(19) United States
(12) Patent Application Publication
(10) Pub. No.: US 2017/0193884 A1
(43) Pub. Date: Jul. 6, 2017

(54) DISPLAY DEVICE AND DRIVING METHOD AND DRIVING MODULE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Quanhua HE, Beijing (CN); Hao ZHANG, Beijing (CN); Lingyun SHI, Beijing (CN); Guangquan WANG, Beijing (CN)

(21) Appl. No.: 15/107,045

(22) PCT Filed: Jan. 14, 2016
(86) PCT No.: PCT/CN2016/070857

§ 371 Date: Jun. 21, 2016

(30) Foreign Application Priority Data
Jul. 20, 2015 (CN) 201510428070.1

(51) Int. Cl. G09G 3/20

(52) U.S. Cl. CPC G09G 3/2092; G09G 2330/021; G09G 2310/0202; G09G 2310/0243; G09G 2300/0426; G09G 2340/0407

(57) ABSTRACT

The present invention provides a driving method for a display device, comprising: determining a relationship between the remaining capacity of the power source and all of the predetermined threshold values; if the remaining capacity of the power source is higher than all of the predetermined threshold values, controlling the display panel to display with the first resolution and scanning the display panel at a first frequency; if the remaining capacity of the power source is lower than one of the predetermined threshold values, controlling the display panel to display with a resolution lower than the first resolution and scanning the display panel at a second frequency, wherein the second frequency is lower than the first frequency. The present invention also provides a drive module and a display device. The power consumption of the display device can be reduced, and endurance of the power source can be extended.

### FIELD OF THE INVENTION

The present invention relates to the field of display devices, in particular to a driving method of a display device, a driving module for implementing the driving method and a display device comprising the driving module.

### BACKGROUND OF THE INVENTION

A variety of display devices (such as mobile phones, laptops, tablets, etc.) become an important part in people's life, thus the endurance capability of a display device becomes an important criterion representing the performance of the display device.

The most commonly used means for improving endurance capability of the display devices is to improve the manufacturing process, thereby reducing area of the wafer used in electronic devices. As the area of the wafer becomes smaller, less power consumption is caused by the display device. However, being limited by the current level of technology, wafer area cannot be unlimitedly decreased.

An alternative approach to improve endurance capability of the display device is to dim the brightness of the display device when the power capacity is reduced to a certain level. However, this approach hinders the user from continue operation to the display device and lowers the operation experience.

As above, how to improve the endurance capability of the display device without hindrance to continue operation and poor user experience becomes a technical problem to be solved in the art.

### SUMMARY OF THE INVENTION

An object of the present invention is to provide a driving method for a display device, a driving module for implementing the driving method and a display device comprising the driving module. The driving method for driving the display device is capable of reducing power consumption, while normal operation of the display device is not interfered.

To achieve the above object, as one aspect of the present invention, there is provided a driving method for a display device which comprises a display panel and a power source for supplying power to the display panel, wherein at least one predetermined threshold value is set according to the power capacity of the power source, each predetermined threshold value corresponding to a resolution smaller than a first resolution, and the smaller the predetermined threshold value is, the lower the corresponding resolution is, the driving method comprising:

determining a relationship between the remaining capacity of the power source and the at least one predetermined threshold values;

if the remaining capacity of the power source is higher than the at least one predetermined threshold value, controlling the display panel to display with the first resolution and scanning the display panel at a first frequency;

if the remaining capacity of the power source is lower than the at least one predetermined threshold value, controlling the display panel to display with a resolution lower than the first resolution and scanning the display panel at a second frequency, wherein the second frequency is lower than the first frequency.

Preferably, there is one predetermined threshold value.

Preferably, there is a plurality of predetermined threshold values, when the remaining capacity of the power source is lower than any one of the plurality of predetermined threshold values, the display panel is controlled to display with a resolution corresponding to the lowest one of the predetermined threshold values which are higher than the remaining capacity of the power source.

Preferably, the step of controlling the display panel to display with a resolution lower than the first resolution, if the remaining capacity of the power source is lower than one of the at least one predetermined threshold value, comprising:

processing initial display data to obtain processed display data, wherein the resolution of the image corresponding to the initial display data is the first resolution, the resolution of the image corresponding to the processed display data is the resolution lower than the first resolution;

generating a processed driving signal based on the processed display data;

driving the display panel to display using the processed driving signal.

Preferably, the step of generating a processed driving signal based on the processed display data comprises:

generating corresponding source driving signal according to the display data, wherein data lines of the display panel are divided into a plurality of groups, each group including a plurality of data lines, the source driving signals for the plurality of data lines in a same group are the same when a frame of image is displayed;

generating corresponding scanning signal according to the display data, wherein the gate lines of the display panel are divided into a plurality of groups, each group including a plurality of gate lines, the scanning signals for the plurality of gate lines in a same group are the same when a frame of image is displayed.

Preferably, when a frame of image is displayed, a plurality of source signal output terminals corresponding to each group of data lines are controlled to output the same source driving signal; and/or, when a frame of image is displayed, a plurality of scanning signal output terminals corresponding to each group of gate lines are controlled to output the same scanning signal.

Preferably, when a frame of image is displayed, one source signal output terminal among the plurality of source signal output terminals corresponding to each group of data lines is controlled to output the source driving signal, and the data lines in the group are shorted; and/or, when a frame of image is displayed, one scanning signal output terminal among the plurality of scanning signal output terminals corresponding to each group of gate lines is controlled to output the scanning signal, and the gate lines in the group are shorted.

Preferably, the first resolution is any one of 960×540, 1080×1920, 3840×2160.

Preferably, the resolution lower than the first resolution is 720×1080 or 480×800.

Preferably, the first frequency is higher than the second frequency.

As another aspect of the present invention, there is provided a drive module for driving a display panel, wherein at least one predetermined threshold value is set according to power capacity of a power source for supplying the display panel, each predetermined threshold value corresponding to a resolution lower than a first resolution, and the smaller the predetermined threshold value is, the lower the corresponding resolution is, the drive module comprising:

a power capacity diagnosis unit for determining a relationship between the remaining capacity of the power source and the at least one predetermined threshold value, wherein the power capacity diagnosis unit is capable of generating control signals corresponding to the respective predetermined threshold values;

a processing unit, if the power capacity diagnosis unit determines that the remaining capacity of the power source is lower than one of the at least one predetermined threshold value, the power capacity diagnosis unit sends a control signal to the processing unit, upon receipt of the control signal, the processing unit controls the display panel to display with a resolution corresponding to the control signal, and scans the display panel at a second frequency; if no control signal is received, the processing unit controls the display panel to display with the first resolution, and scans the display panel at a first frequency, wherein the first frequency is higher than the second frequency.

Preferably, there is one predetermined threshold value.

Preferably, there is a plurality of predetermined threshold values, and the resolution corresponding to the control signal is a resolution corresponding to a smallest one of the predetermined threshold values which are higher than the remaining capacity of the power source.

Preferably, the processing unit comprises an application processing subunit and a driving circuit subunit,

the application processing subunit is configured to receive the control signal, and process the initial display data upon receipt of the control signal to obtain processed display data, the resolution of the image corresponding to the initial display data is the first resolution, the resolution of the image corresponding to the processed display data is the resolution lower than the first resolution; the application processing subunit is also configured to send the processed display data to the driving circuit subunit;

the driving circuit subunit is configured to convert the processed display data into a corresponding driving signal upon receipt of the processed display data, and send the driving signal to the display panel.

Preferably, data lines of the display panel are divided into a plurality of groups, each group including a plurality of data lines, gate lines of the display panel are divided into a plurality of groups, each group including a plurality of gate lines, the driving circuit subunit comprises a source driving subunit and a gate driving subunit, the driving signal includes a source driving signal and a scanning signal, the source driving subunit is configured to generate the source driving signal based on the processed display data, the gate driving subunit is configured to generate the scanning signal based on the processed display data; upon receipt of the control signal, the source driving signals output from the source driving subunit to the plurality of data lines in a same group are the same, and the scanning signals output from the gate driving subunit to the plurality of gate lines in a same group are the same.

Preferably, the application processing subunit is configured to generate an enable signal after the control signal is received, and send the enable signal to the driving circuit subunit,

data lines of the display panel are divided into a plurality of groups, each group including a plurality of data lines, gate lines of the display panel are divided into a plurality of groups, each group including a plurality of gate lines, the driving circuit subunit comprises a source driving subunit and a gate driving subunit, the drive module further comprises a data line switch unit and a gate line switch unit, the driving signal includes a source driving signal and a scanning signal,

when the enable signal is received by the source driving subunit, the source driving signal is output from one source signal output terminal among the plurality of source signal output terminals of the source driving subunit corresponding to each group of data lines, and the data lines in the group are shorted by the data line switch unit;

when the enable signal is received by the gate driving subunit, the scanning signal is output from one scanning signal output terminal among the plurality of scanning signal output terminals of the gate driving subunit corresponding to each group of gate lines, and the gate lines in the group are shorted by the gate line switch unit.

Preferably, the first resolution is any one of 960×540, 1080×1920, 3840×2160.

Preferably, the resolution lower than the first resolution is 720×1080 or 480×800.

Preferably, the first frequency is higher than the second frequency.

As another aspect of the present invention, there is provided a display device comprising a power source, a drive module and a display panel, the drive module is configured for generating a drive signal for driving the display panel, the power source is configured for supplying power to the drive module and the display panel, wherein the drive module is the above drive module provided by the present invention.

If the remaining capacity of the power source is lower than the first predetermined threshold values, the display panel is controlled to display with a resolution lower than the first resolution, and the display panel is scanned at a second frequency, wherein the second frequency is no larger than the first frequency. The data amount of the display data when displaying with the resolution lower than the first resolution is less than the data amount of the display data when displaying with the first resolution, therefore the power consumption when displaying with the resolution lower than the first resolution is lower than the power consumption when displaying with the first resolution. Thus, when the driving method of the present invention is used for driving the display device, if the capacity of the power source is lower than a predetermined threshold value, the display resolution is lowered, thereby the power consumption of the display device can be reduced effectively, and endurance of the power source can be extended. While the display resolution is lowered, the brightness of the display device is not required to be lowered, and therefore the operation to the display device is not influenced.

Furthermore, when the driving method of the present invention is used for driving the display device, the manufacturing process of the display device is not particularly limited, but can be performed using existing manufacturing process without requirements of reducing the wafer area, thereby the producing cost of the display device can be reduced.

### BRIEF DESCRIPTION OF THE DRAWINGS

The drawings are used to provide further understanding of the present invention, constitute a part of the specification, and used to interpret the present invention together with the following detailed embodiments, but not to limit the present invention. In the drawings:

FIG. 1 is a flowchart of an embodiment of the driving method according to the present invention;

FIG. 2 is a flowchart of another embodiment of the driving method according to the present invention;

FIG. 3 is a block diagram of a display device according to the present invention;

FIG. 4a shows a first connection manner between the shift register unit and the gate lines in the gate driving subunit according to the present invention;

FIG. 4b shows a second connection manner between the shift register unit and the gate lines in the gate driving subunit according to the present invention.

Reference numerals

| | |
|---|---|
| 100: power capacity diagnosis unit | 200: processing unit |
| 210: application processing subunit | 220: driving circuit subunit |
| 221: source driving subunit | 222: gate driving subunit |
| 300: display panel | 400: data line switch unit |
| 500: gate line switch unit | 600: power source |
| 222a, 222b: shift register unit | 310a, 310b: gate line |

### DETAILED DESCRIPTION OF THE EMBODIMENTS

The specific embodiments of the present invention will be described in detail below in combination with the accompanying drawings. It should be understood that these embodiments are provided for explanation and illustration to the present invention, rather than limitation to the present invention.

As one aspect of the present invention, there is provided a driving method for a display device which comprises a display panel and a power source for supplying power to the display panel, wherein at least one predetermined threshold value is set according to the power capacity of the power source, each predetermined threshold value corresponding to a resolution smaller than a first resolution, and the smaller the predetermined threshold value is, the lower the corresponding resolution is, the driving method comprising:

determining a relationship between the remaining capacity of the power source and all of the predetermined threshold values;

if the remaining capacity of the power source is higher than one of all of the predetermined threshold values, controlling the display panel to display with the first resolution and scanning the display panel at a first frequency;

if the remaining capacity of the power source is lower than one of the predetermined threshold values, controlling the display panel to display with a resolution lower than the first resolution and scanning the display panel at a second frequency, wherein the second frequency is lower than the first frequency.

The data amount of the display data when displaying with the resolution lower than the first resolution is less than the data amount of the display data when displaying with the first resolution, therefore the power consumption when displaying with the resolution lower than the first resolution is lower than the power consumption when displaying with the first resolution. Thus, when the driving method of the present invention is used for driving the display device, if the capacity of the power source is lower than a predetermined threshold value, the display resolution is lowered, thereby the power consumption of the display device can be reduced effectively, and endurance of the power source can be extended. While the display resolution is lowered, the brightness of the display device is not required to be lowered, therefore the operation to the display device is not influenced. Furthermore, as the frequency of scanning the display panel is lowered, less power consumption is induced. Therefore, by scanning the display panel at a second frequency lower than the first frequency, the power consumption can be further reduced, and endurance of the power source can be extended.

Furthermore, when the driving method of the present invention is used for driving the display device, the manufacturing process of the display device is not particularly limited, but can be performed using existing manufacturing process without requirements of reducing the wafer area, thereby the producing cost of the display device can be reduced.

In the present invention, the specific values of the first frequency and the second frequency are not particularly limited, for example, the first frequency may be 60 Hz, and the second frequency may be 30 Hz.

It is readily understood that said “at least one predetermined threshold value” includes two cases: there is only one predetermined threshold value, and there are a plurality of predetermined threshold values.

When a plurality of predetermined threshold values are provided, the “largest predetermined threshold value” refers to a largest one among the plurality of predetermined threshold values.

As to “the lowest one of the predetermined threshold values which are higher than the remaining capacity of the power source”, two cases are included: if only the largest predetermined threshold value is higher than the remaining capacity of the power source, “the lowest one of the predetermined threshold values which are higher than the remaining capacity of the power source” refers to the largest predetermined threshold value; and if there are a plurality of predetermined threshold values which are higher than the remaining capacity of the power source, “the lowest one of the predetermined threshold values which are higher than the remaining capacity of the power source” refers to the smallest one of the predetermined threshold values which are higher than the remaining capacity of the power source.

In the present invention, there is no special requirement for the magnitude of the predetermined threshold value and the specific number of the predetermined threshold values. For example, the largest predetermined threshold value may be 30% or less of a maximum of the power capacity. Alternatively, the predetermined threshold value may be customized by the user. For example, the predetermined threshold value may be set by the user through an application, so as to meet different user's habits and operational requirements.

As a preferred embodiment of the present invention, there may be only one predetermined threshold value. When the remaining power capacity is lower than the predetermined threshold value, the resolution of the display image of the display device is lowered. This driving method is relatively simple and easy to implement.

As another preferred embodiment of the present invention, the display resolution of the display device can be regulated in multiple levels according to the remaining power capacity, that is, a plurality of predetermined threshold values are provided. Said plurality of predetermined threshold values are gradually lowered, and each predetermined threshold value corresponds to one resolution, wherein the smaller the predetermined threshold value is, the lower the corresponding resolution is.

When the remaining capacity of the power source is lower than the smallest predetermined threshold value, the display panel is controlled to display with a resolution corresponding to the smallest predetermined threshold value;

when the remaining capacity of the power source is located between two adjacent predetermined threshold values, the display panel is controlled to display with a resolution corresponding to the larger one of the two adjacent predetermined threshold values.

In a specific embodiment, the plurality of predetermined threshold values may comprise a first predetermined threshold value, a second predetermined threshold value and a third predetermined threshold value which are gradually decreased, the first predetermined threshold value is set to be 30% of a maximum of the power capacity, the second predetermined threshold value is set to be 20% of a maximum of the power capacity, and the third predetermined threshold value is set to be 10% of a maximum of the power capacity. Accordingly, the first predetermined threshold value corresponds to a second resolution, the second predetermined threshold value corresponds to a third resolution, the third predetermined threshold value corresponds to a fourth resolution. The first resolution, the second resolution, the third resolution and the fourth resolution meet the following relationship: the first resolution>the second resolution>the third resolution>the fourth resolution.

When the remaining capacity of the power source is higher than the first predetermined threshold value, the display panel is controlled to display with the first resolution. When the remaining capacity of the power source is located between the first and second predetermined threshold values, the display panel is controlled to display with the second resolution corresponding to the first predetermined threshold value. When the remaining capacity of the power source is located between the second and third predetermined threshold values, the display panel is controlled to display with the third resolution corresponding to the second predetermined threshold value. When the remaining capacity of the power source is lower than the third predetermined threshold value, the display panel is controlled to display with the fourth resolution corresponding to the third predetermined threshold value.

According to the above driving method for the display device, the resolution of the display device is gradually decreased with consumption of the power capacity, thereby the user's visual experience would not be abruptly reduced. Moreover, the power consumption of the display device can be gradually reduced, and a compromise between the visual experience and operation time can be achieved.

According to the application environment of the display device and specific requirements of the users, one or more predetermined threshold values can be set.

In a specific embodiment of the present invention, the step of controlling the display panel to display with a resolution lower than the first resolution, if the remaining capacity of the power source is lower than one of the predetermined threshold values, comprising:

processing initial display data to obtain processed display data, the resolution of the image corresponding to the initial display data is the first resolution, the resolution of the image corresponding to the processed display data is lower than the first resolution;

generating a processed driving signal based on the processed display data;

driving the display panel to display using the processed driving signal.

Note that the image corresponding to the initial display data has the same content as the image corresponding to the processed display data, however, the resolution of the image corresponding to the processed display data is lower than the resolution of the image corresponding to the initial display data.

In the present invention, the implementation of the step of “generating a processed driving signal based on the processed display data” is not limited, as long as the display panel can be driven by the processed driving signal to display image with a lowered resolution.

In a preferred embodiment of the present invention, the step of generating a processed driving signal based on the processed display data comprises:

generating corresponding source driving signal according to the display data, wherein data lines of the display panel are divided into a plurality of groups, each group including a plurality of data lines, the source driving signals for the plurality of data lines in a same group are the same when a frame of image is displayed;

generating corresponding scanning signal according to the display data, wherein gate lines of the display panel are divided into a plurality of groups, each group including a plurality of gate lines, the scanning signals for the plurality of gate lines in a same group are the same when a frame of image is displayed.

Since the source driving signals for the data lines in a same group are the same, and the scanning signals for the gate lines in a same group are the same, the resolution of the image displayed by the display panel is lower than the first resolution.

Preferably, when a frame of image is displayed, a plurality of source signal output terminals corresponding to each group of data lines are controlled to output the same source driving signal; and/or, when a frame of image is displayed, a plurality of scanning signal output terminals corresponding to each group of gate lines are controlled to output the same scanning signal.

In the present invention, the scanning signals can be output using a shift register (GOA) or a gate driving circuit chip (Gate/IC). That is, the scanning signal output terminals may be the output terminals of the shift register units in the shift register, or the output terminals of the gate driving circuit chip.

For a further decrease in power consumption, preferably, when a frame of image is displayed, one source signal output terminal among the plurality of source signal output terminals corresponding to each group of data lines is controlled to output the source driving signal, and the data lines in the group are shorted; and/or, when a frame of image is displayed, one scanning signal output terminal among the plurality of scanning signal output terminals corresponding to each group of gate lines is controlled to output the scanning signal, and the gate lines in the group are shorted.

When the data lines in a group are shorted, the signals on the data lines of the same group are the same. When the gate lines in a group are shorted, the signals on the gate lines of the same group are the same. Thus an image can be displayed with a resolution lower than the first resolution.

In above embodiments, the number of signals output from the gate driver and the source driver in the driving circuit is decreased, thereby the power consumption of the driving circuit can be reduced, and the endurance of the power source can be extended.

It should be noted that, in the present invention, the amount of data lines in different groups may be the same or different. Similarly, the amount of gate lines in different groups may be the same or different. For example, when the first resolution is A×B, the gate lines may be divided into A/2 groups, each group includes two gate lines, the data lines may be divided into B/2 groups, each group of data lines includes two data lines. Alternatively, the gate lines may be divided into n groups, some groups may each comprise two gate lines, and some groups may each comprise three gate lines. Likewise, the data lines may be divided into n groups, some group may each comprise two data lines, and some groups may each comprise three data lines.

The specific configurations for shorting the data lines in a same group and for shorting the gate lines in a same group will be described hereinafter.

Those skilled in the art would understand that the above description is merely example for easy understanding, rather than limitation to the grouping manner of the gate lines and the data lines.

In the present invention, there is no particular limitation to the specific value of the first resolution, for example, when the remaining capacity of the power source is higher than the predetermined threshold value, the display panel may be controlled to output FHD resolution, the resolution for FHD display is 1080×1920, and accordingly the first resolution is 1080×1920. The first resolution may be QHD (i.e. 960×540) or FHD (3840×2160). Of course, the present invention is not limited thereto.

When the remaining capacity of the power source is lower than the predetermined threshold value, the display panel may be controlled to output HD resolution (720×1080) or WVGA resolution (480×800). Of course, the present invention is not limited thereto.

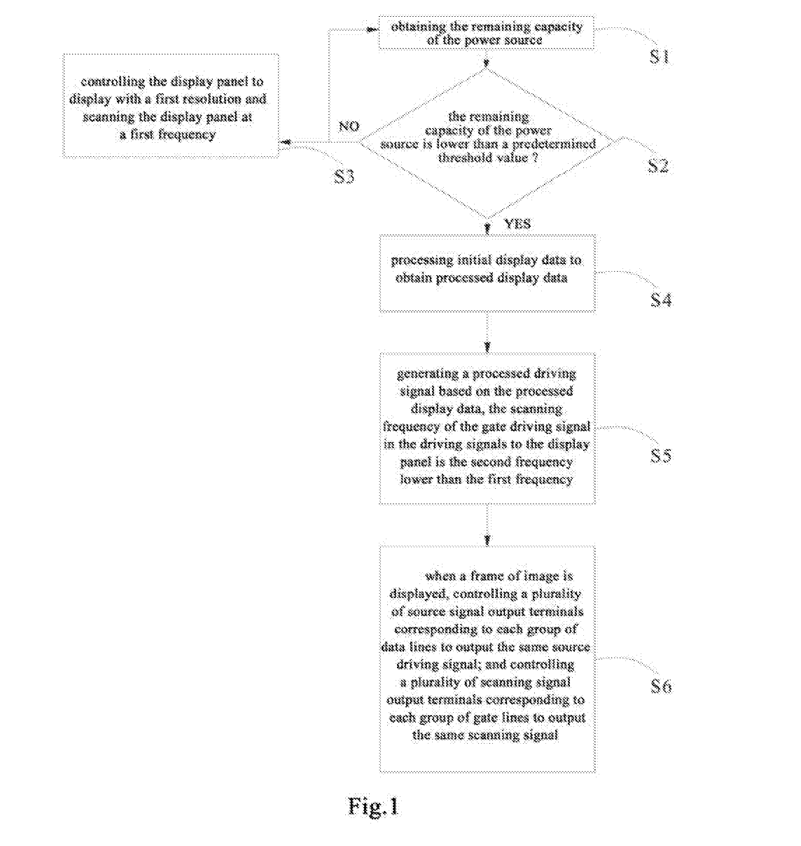

FIG. 1 is a flowchart of an embodiment of the driving method according to the present invention. In the embodiment as shown in FIG. 1, only one predetermined threshold value is set. As shown in the figure, the driving method comprises:

S1, obtaining the remaining capacity of the power source;

S2, determining whether the remaining capacity of the power source is lower than the predetermined threshold value;

if the remaining capacity of the power source is not lower than the predetermined threshold value, continue performing steps S1 and S3;

if the remaining capacity of the power source is lower than the predetermined threshold value, performing steps S4 to S6;

S3, controlling the display panel to display with the first resolution and scanning the display panel at the first frequency;

S4, processing initial display data to obtain processed display data;

S5, generating a processed driving signal based on the processed display data, the scanning frequency of the scanning signal in the driving signal to the display panel is the second frequency lower than the first frequency;

S6, when a frame of image is displayed, controlling a plurality of source signal output terminals corresponding to each group of data lines to output the same source driving signal; and controlling a plurality of scanning signal output terminals corresponding to each group of gate lines to output the same scanning signal.

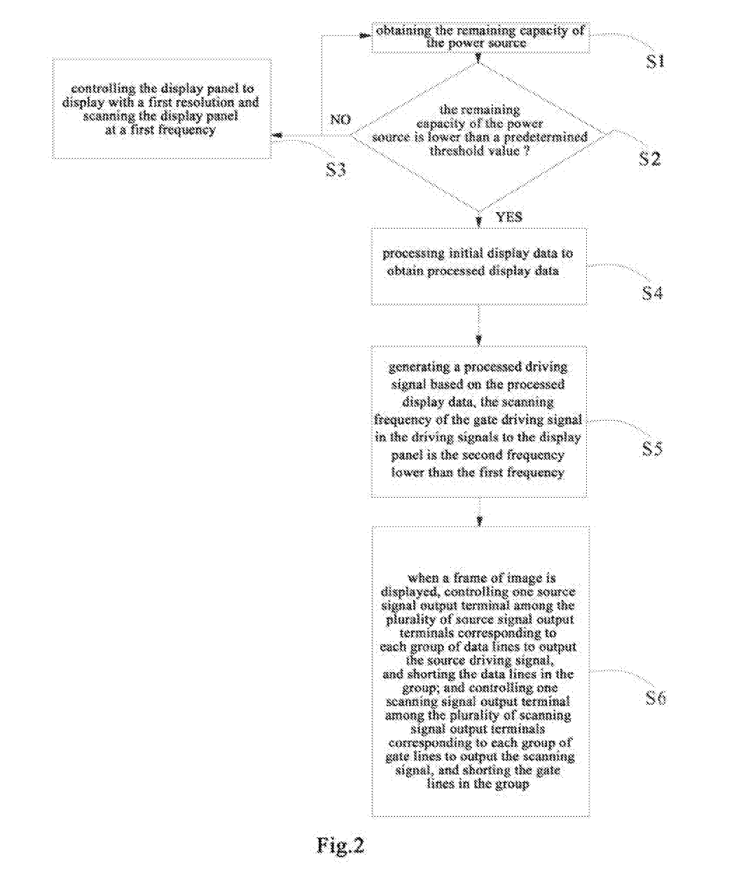

FIG. 2 shows a preferred embodiment of the driving method according to the present invention. In this embodiment, only one predetermined threshold value is set. The driving method comprises:

S1, obtaining the remaining capacity of the power source;

S2, determining whether the remaining capacity of the power source is lower than the predetermined threshold value;

if the remaining capacity of the power source is not lower than the predetermined threshold value, continue performing steps S1 and S3;

if the remaining capacity of the power source is lower than the predetermined threshold value, performing steps S4 to S6;

S3, controlling the display panel to display with the first resolution and scanning the display panel at the first frequency;

S4, processing initial display data to obtain processed display data;

S5, generating a processed driving signal based on the processed display data, the scanning frequency of the scanning signal in the driving signal to the display panel is the second frequency lower than the first frequency;

S6, when a frame of image is displayed, controlling one source signal output terminal among the plurality of source signal output terminals corresponding to each group of data lines to output the source driving signal, and shorting the data lines in the group; and controlling one scanning signal output terminal among the plurality of scanning signal output terminals corresponding to each group of gate lines to output the scanning signal, and shorting the gate lines in the group.

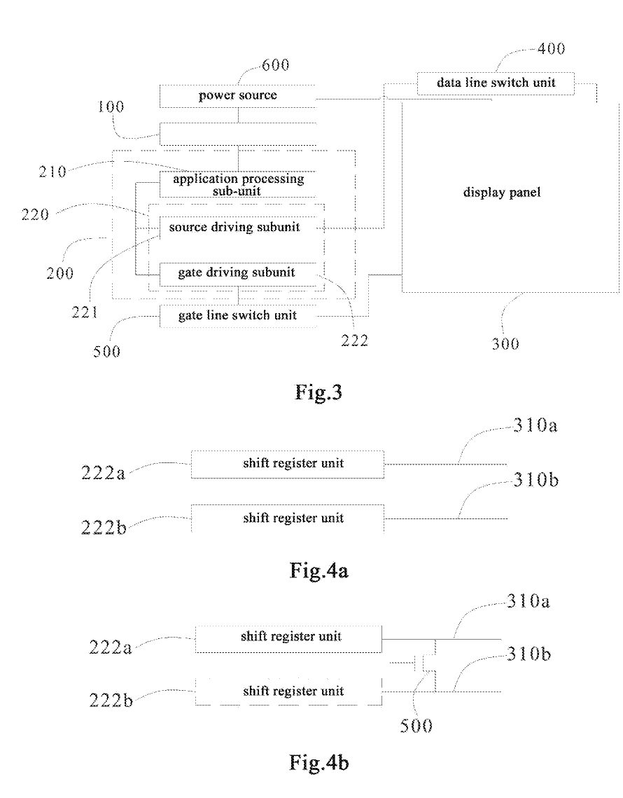

As another aspect of the present invention, there is provided a drive module for driving the display panel. As discussed above, at least one predetermined threshold value is set according to the power capacity of the power source for supplying the display panel, each predetermined threshold value corresponding to a resolution lower than a first resolution, and the smaller the predetermined threshold value is, the lower the corresponding lower resolution is. As shown in FIG. 3, the drive module comprises a power capacity diagnosis unit 100 and a processing unit 200.

The power capacity diagnosis unit 100 is configured for determining a relationship between the remaining capacity of the power source 600 for supplying the display panel 300 and the predetermined threshold values, the power capacity diagnosis unit 100 is capable of generating control signals corresponding to the respective predetermined threshold values; when the power capacity diagnosis unit 100 determines the remaining capacity of the power source is lower than any one of the at least predetermined threshold value, the power capacity diagnosis unit 100 sends a control signal to the processing unit 200, wherein the control signal corresponds to a smallest one of the predetermined threshold values which are higher than the remaining capacity of the power source.

The processing unit 200 is configured for, upon receipt of the control signal, controlling the display panel 300 to display with a resolution corresponding to the control signal, and scanning the display panel 300 at the second frequency. If no control signal is received, the processing unit 200 controls the display panel 300 to display with the first resolution, and scans the display panel 300 at a first frequency, wherein the first frequency is higher than the second frequency.

Note that each predetermined threshold value corresponds to a control signal, and each predetermined threshold value corresponds to a resolution, therefore each control signal corresponds to a resolution.

As discussed above, the data amount of the display data when displaying with the resolution lower than the first resolution is less than the data amount of the display data when displaying with the first resolution, therefore the power consumption when displaying with the resolution lower than the first resolution is lower than the power consumption when displaying with the first resolution. Thus, when the driving method of the present invention is used for driving the display device, if the capacity of the power source is lower than a predetermined threshold value, the display resolution is lowered, thereby the power consumption of the display device can be reduced effectively, and endurance of the power source can be extended. While the display resolution is lowered, the brightness of the display device is not required to be lowered, and therefore the user operation to the display device is not influenced. As the frequency of scanning the display panel is lowered, less power consumption is induced, thus by setting the second resolution to be lower than the first resolution, the power consumption can be further reduced, and the endurance of the power source can be extended.

Furthermore, in the present invention, the manufacturing process of the display device is not particularly limited, but can be performed using existing manufacturing process without requirements of reducing the wafer area, thereby the producing cost of the display device can be reduced.

As a preferred embodiment of the present invention, there may be one predetermined threshold value. When the remaining power capacity is lower than the predetermined threshold value, the resolution of the display image of the display device is lowered.

Also, as discussed above, the display resolution of the display device can be regulated in multiple levels according to the remaining power capacity, that is, a plurality of predetermined threshold values are provided. Said plurality of predetermined threshold values are gradually lowered, and each predetermined threshold value corresponds to one resolution, wherein the smaller the predetermined threshold value is, the lower the corresponding resolution is.

The drive module may be configured as follows:

when the power capacity diagnosis unit 100 determines the remaining capacity of the power source is lower than the smallest one of the predetermined threshold values, the power capacity diagnosis unit 100 generates a control signal corresponding to the smallest one of the predetermined threshold values, and sends the control signal to the processing unit 200; upon receipt of the control signal, the processing unit 200 controls the display panel 300 to display with a resolution corresponding to the smallest predetermined threshold value;

when the power capacity diagnosis unit 100 determines the remaining capacity of the power source is located between two adjacent predetermined threshold values, the power capacity diagnosis unit 100 generates a control signal corresponding to the larger one of the two adjacent predetermined threshold values, and sends the control signal to the processing unit 200; upon receipt of the control signal, the processing unit 200 controls the display panel 300 to display with a resolution corresponding to the larger one of the two predetermined threshold values.

When the above driving method is used for driving the display device, the resolution of the display device is gradually decreased with consumption of the power capacity, thereby the user's visual experience would not be abruptly reduced. Moreover, the power consumption of the display device can be gradually reduced, and a compromise between the visual experience and the operation time can be achieved.

Hereinafter, a specific implementation of the processing unit 200 will be described. In this embodiment, the processing unit 200 comprises an application processing subunit 210 and a driving circuit subunit 220.

The application processing subunit 210 is configured to receive the control signal, and process the initial display data upon receipt of the control signal to obtain processed display data, the resolution of the image corresponding to the initial display data is the first resolution, the resolution of the image corresponding to the processed display data is lower than the first resolution; the application processing subunit is also configured to generate an enable signal, and send the processed display data and the enable signal to the driving circuit subunit 220.

The driving circuit subunit 220 is configured to convert the processed display data into a corresponding driving signal upon receipt of the enable signal and the processed display data, and send the driving signal to the display panel 300.

When the display device of the present invention is included in an electronic equipment such as a smart phone and a tablet computer, the application processing subunit 210 may be integrated in the application processor of the display device, so as to enhance the integration degree of the display device.

In order to display image with a lowered resolution, preferably, the data lines of the display panel 300 are divided into a plurality of groups, each group including a plurality of data lines. The gate lines of the display panel 300 are divided into a plurality of groups, each group including a plurality of gate lines. The driving circuit subunit 220 comprises a source driving subunit 221 and a gate driving subunit 222, the driving signal includes the source driving signal and the scanning signal, the source driving subunit 221 is configured to generate the source driving signal based on the processed display data, the gate driving subunit 222 is configured to generate the scanning signal based on the processed display data. Upon receipt of the control signal, the source driving signals output from the source driving subunit 221 to the plurality of data lines in a same group are the same, and the scanning signals output from the gate driving subunit 222 to the plurality of gate lines in a same group are the same.

As shown in FIG. 4a, the shift register unit 222a of the gate driving subunit is connected with a gate line 310a, and the shift register unit 222b of the gate driving subunit is connected with a gate line 310b. When a control signal is received, the shift register unit 222a and the shift register unit 222b of the gate driving subunit output the same scanning signal, so as to provide the same scanning signal on the gate lines 310a and 310b.

As another embodiment of the present invention, preferably, the application processing subunit 210 is configured to generate an enable signal after the control signal is received, and send the enable signal to the driving circuit subunit 220.

In this embodiment, the data lines of the display panel 300 are divided into a plurality of groups, each group including a plurality of data lines, and the gate lines of the display panel 300 are divided into a plurality of groups, each group including a plurality of gate lines. The driving circuit subunit 220 comprises a source driving subunit 221 and a gate driving subunit 222. The drive module further comprises a data line switch unit 400 and a gate line switch unit 500.

The driving signal includes the source driving signal and the scanning signal, when the enable signal is received by the source driving subunit 221, the source driving signal is output from one source signal output terminal among the plurality of source signal output terminals of the source driving subunit 221 corresponding to each group of data lines, and the data lines in the group are shorted by the data line switch unit 400.

When the enable signal is received by the gate driving subunit 222, the scanning signal is output from one scanning signal output terminal among the plurality of scanning signal output terminals of the gate driving subunit 222 corresponding to each group of gate lines, and the gate lines in the group are shorted by the gate line switch unit 500.

As shown in FIG. 4b, when the enable signal is received, the shift register unit 222b is shut off, no scanning signal is output. The gate line switch unit 500 shorts the gate lines 310a and 310b, so that the same scanning signal is provided on the gate lines 310a and 310b.

Since the signal amount output from the source driving subunit and the gate driving subunit are both decreased, the above drive module can further reduce power consumption.

In the present invention, the specific configuration of the data line switch unit 400 and the gate line switch unit 500 is not limited.

As shown in FIG. 4b, the gate line switch unit 500 may include a thin film transistor, a first electrode and a second electrode of the thin film transistor are connected to two adjacent gate lines 310a, 310b respectively, and the gate of the thin film transistor is connected to the control voltage output terminal. The enable signal enables the control voltage output terminal to output a voltage to the gate of the thin film transistor for making the thin film transistor turned on, such that the two adjacent gate lines are shorted.

Accordingly, the data line switch unit 400 may have a similar structure, which is not repeated here.

In the present invention, there is no particular limitation to the specific value of the first resolution, for example, when the remaining capacity of the power source is higher than the predetermined threshold value, the display panel may be controlled to output FHD resolution, the resolution for FHD display is 1080×1920, and accordingly the first resolution is 1080×1920.

When the remaining capacity of the power source is lower than the predetermined threshold value, the display panel may be controlled to output HD resolution (720×1080) or WVGA resolution (480×800).

As another aspect of the present invention, there is provided a display device comprising a power source 600, a drive module and a display panel 300, the drive module is configured for generating a driving signal for driving the display panel 300, the power source 600 is configured for supplying power to the drive module and the display panel 300, wherein the drive module is the above drive module provided by the present invention.

In the present invention, the display device may be a mobile terminal device such as a smart phone and a tablet computer.

When the capacity of the power source of the display device is lower than a predetermined threshold value, the display resolution is lowered, thereby the power consumption of the display device can be reduced, and endurance of the power source can be extended.

It could be understood that, the above embodiments are merely exemplary embodiments adopted for describing the principle of the present invention, but the present invention is not limited thereto. Various modifications and improvements may be made by a person skilled in the art without departing from the spirit and essence of the present invention, and these modifications and improvements are considered to be within the protection scope of the present invention.

1-18. (canceled)

19. A driving method for a display device which comprises a display panel and a power source for supplying power to the display panel, wherein at least one predetermined threshold value is set according to the power capacity of the power source, each predetermined threshold value corresponding to a resolution smaller than a first resolution, and the smaller the predetermined threshold value is, the lower the corresponding resolution is, the driving method comprising:
determining a relationship between the remaining capacity of the power source and the at least one predetermined threshold values;
if the remaining capacity of the power source is higher than the at least one predetermined threshold value, controlling the display panel to display with the first resolution and scanning the display panel at a first frequency;
if the remaining capacity of the power source is lower than one of the at least one predetermined threshold value, controlling the display panel to display with a resolution lower than the first resolution and scanning the display panel at a second frequency, wherein the second frequency is lower than the first frequency.

20. The driving method of claim 19, wherein there is one predetermined threshold value.

21. The driving method of claim 19, wherein there is a plurality of predetermined threshold values, when the remaining capacity of the power source is lower than any one of the plurality of predetermined threshold values, the display panel is controlled to display with a resolution corresponding to the lowest one of the predetermined threshold values which are higher than the remaining capacity of the power source.

22. The driving method of claim 19, wherein the step of controlling the display panel to display with a resolution lower than the first resolution, if the remaining capacity of the power source is lower than one of the at least one predetermined threshold value, comprising:
processing initial display data to obtain processed display data, wherein the resolution of the image corresponding to the initial display data is the first resolution, the resolution of the image corresponding to the processed display data is the resolution lower than the first resolution;
generating a processed driving signal based on the processed display data;
driving the display panel to display using the processed driving signal.

23. The driving method of claim 20, wherein the step of controlling the display panel to display with a resolution lower than the first resolution, if the remaining capacity of the power source is lower than one of the at least one predetermined threshold value, comprising:
processing initial display data to obtain processed display data, wherein the resolution of the image corresponding to the initial display data is the first resolution, the resolution of the image corresponding to the processed display data is the resolution lower than the first resolution;
generating a processed driving signal based on the processed display data;
driving the display panel to display using the processed driving signal.

24. The driving method of claim 22, wherein the step of generating a processed driving signal based on the processed display data comprises:
generating corresponding source driving signal according to the display data, wherein data lines of the display panel are divided into a plurality of groups, each group including a plurality of data lines, and the source driving signals for the plurality of data lines in a same group are the same when a frame of image is displayed;
generating corresponding scanning signal according to the display data, wherein the gate lines of the display panel are divided into a plurality of groups, each group including a plurality of gate lines, and the scanning signals for the plurality of gate lines in a same group are the same when a frame of image is displayed.

25. The driving method of claim 24, wherein when a frame of image is displayed, a plurality of source signal output terminals corresponding to each group of data lines are controlled to output the same source driving signal; and/or, when a frame of image is displayed, a plurality of scanning signal output terminals corresponding to each group of gate lines are controlled to output the same scanning signal.

26. The driving method of claim 24, wherein when a frame of image is displayed, one source signal output terminal among the plurality of source signal output terminals corresponding to each group of data lines is controlled to output the source driving signal, and the data lines in the group are shorted; and/or, when a frame of image is displayed, one scanning signal output terminal among the plurality of scanning signal output terminals corresponding to each group of gate lines is controlled to output the scanning signal, and the gate lines in the group are shorted.

27. The driving method of claim 19, wherein the first resolution is any one of 960×540, 1080×1920, 3840×2160.

28. The driving method of claim 20, wherein the first resolution is any one of 960×540, 1080×1920, 3840×2160.

29. The driving method of claim 27, wherein the resolution lower than the first resolution is 720×1080 or 480×800.

30. A drive module for driving a display panel, wherein at least one predetermined threshold value is set according to power capacity of a power source for supplying the display panel, each predetermined threshold value corresponding to a resolution lower than a first resolution, and the smaller the predetermined threshold value is, the lower the corresponding resolution is, the drive module comprising:
a power capacity diagnosis unit for determining a relationship between the remaining capacity of the power source and the at least one predetermined threshold value, wherein the power capacity diagnosis unit is capable of generating control signals corresponding to the respective predetermined threshold values;
a processing unit, if the power capacity diagnosis unit determines that the remaining capacity of the power source is lower than one of the at least one predetermined threshold value, the power capacity diagnosis unit sends a control signal to the processing unit, upon receipt of the control signal, the processing unit controls the display panel to display with a resolution corresponding to the control signal, and scans the display panel at a second frequency; if no control signal is received, the processing unit controls the display panel to display with the first resolution, and scans the display panel at a first frequency, wherein the first frequency is higher than the second frequency.

31. The drive module of claim 30, wherein there is one predetermined threshold value.

32. The drive module of claim 30, wherein there is a plurality of predetermined threshold values, and the resolution corresponding to the control signal is a resolution corresponding to a smallest one of the predetermined threshold values which are higher than the remaining capacity of the power source.

33. The drive module of claim 30, wherein the processing unit comprises an application processing subunit and a driving circuit subunit,
the application processing subunit is configured to receive the control signal, and process the initial display data upon receipt of the control signal to obtain processed display data, the resolution of the image corresponding to the initial display data is the first resolution, the resolution of the image corresponding to the processed display data is the resolution lower than the first resolution; the application processing subunit is also configured to send the processed display data to the driving circuit subunit;
the driving circuit subunit is configured to convert the processed display data into a corresponding driving signal upon receipt of the processed display data, and send the driving signal to the display panel.

34. The drive module of claim 33, wherein data lines of the display panel are divided into a plurality of groups, each group including a plurality of data lines, gate lines of the display panel are divided into a plurality of groups, each group including a plurality of gate lines, the driving circuit subunit comprises a source driving subunit and a gate driving subunit, the driving signal includes a source driving signal and a scanning signal, the source driving subunit is configured to generate the source driving signal based on the processed display data, the gate driving subunit is configured to generate the scanning signal based on the processed display data; upon receipt of the control signal, the source driving signals output from the source driving subunit to the plurality of data lines in a same group are the same, and the scanning signals output from the gate driving subunit to the plurality of gate lines in a same group are the same.

35. The drive module of claim 33, wherein the application processing subunit is configured to generate an enable signal after the control signal is received, and send the enable signal to the driving circuit subunit,
data lines of the display panel are divided into a plurality of groups, each group including a plurality of data lines, gate lines of the display panel are divided into a plurality of groups, each group including a plurality of gate lines, the driving circuit subunit comprises a source driving subunit and a gate driving subunit, the drive module further comprises a data line switch unit and a gate line switch unit, the driving signal includes a source driving signal and a scanning signal,
when the enable signal is received by the source driving subunit, the source driving signal is output from one source signal output terminal among the plurality of source signal output terminals of the source driving subunit corresponding to each group of data lines, and the data lines in the group are shorted by the data line switch unit;
when the enable signal is received by the gate driving subunit, the scanning signal is output from one scanning signal output terminal among the plurality of scanning signal output terminals of the gate driving subunit corresponding to each group of gate lines, and the gate lines in the group are shorted by the gate line switch unit.

36. The drive module of claim 30, wherein the first resolution is any one of 960×540, 1080×1920, 3840×2160.

37. The drive module of claim 36, wherein the resolution lower than the first resolution is 720×1080 or 480×800.

38. A display device comprising a power source, a drive module and a display panel, the drive module is configured for generating a drive signal for driving the display panel, the power source is configured for supplying power to the drive module and the display panel, wherein the drive module is the drive module of claim 19.
